(19) United States
(12) Patent Application Publication
(10) Pub. No.: US 2014/0129245 A1
(43) Pub. Date: May 8, 2014

(54) DOCUMENT PROCESSING APPARATUS, DOCUMENT PROCESSING METHOD, AND COMPUTER READABLE MEDIUM

(71) Applicant: FUJI XEROX CO., LTD., Tokyo (JP)

(72) Inventors: Kento Hosoda, Yokohama-shi (JP); Bin Zhou, Yokohama-shi (JP)

(73) Assignee: FUJI XEROX CO., LTD., Tokyo (JP)

(21) Appl. No.: 13/875,937

(22) Filed: May 2, 2013

(30) Foreign Application Priority Data
Nov. 8, 2012 (JP) 2012-246203

(51) Int. Cl. G06Q 50/22; G06Q 10/00

(52) U.S. Cl. CPC G06Q 50/22; G06Q 10/00
USPC 705/2

(57) ABSTRACT

A document processing apparatus includes a document acquiring unit that acquires image information representing an electronic document, a unit that determines whether the electronic document represented by the image information is an electronic document scanned from a document created by a specific hospital, and a storing unit that stores the image information in a memory if the electronic document represented by the image information is not an electronic document that is scanned from a document created by the specific hospital, and stores compressed image information, which is obtained by compressing the image information, in the memory in place of the image information if the electronic document represented by the image information is an electronic document scanned from a document created by the specific hospital.

### CROSS-REFERENCE TO RELATED APPLICATIONS

This application is based on and claims priority under 35 USC 119 from Japanese Patent Application No. 2012-246203 filed Nov. 8, 2012.

### BACKGROUND

### Technical Field

The present invention relates to a document processing apparatus, a document processing method, and a computer readable medium.

### SUMMARY

According to an aspect of the invention, there is provided a document processing apparatus including a document acquiring unit that acquires image information representing an electronic document, a unit that determines whether the electronic document represented by the image information is an electronic document scanned from a document created by a specific hospital, and a storing unit that stores the image information in a memory if the electronic document represented by the image information is not an electronic document that is scanned from a document created by the specific hospital, and stores compressed image information, which is obtained by compressing the image information, in the memory in place of the image information if the electronic document represented by the image information is an electronic document scanned from a document created by the specific hospital.

### BRIEF DESCRIPTION OF THE DRAWINGS

An Exemplary embodiment of the present invention will be described in detail based on the following figures, wherein:

FIG. 1 is a diagram illustrating a document management apparatus;

FIG. 2 is a diagram illustrating a document management table;

FIG. 3 is a diagram illustrating a department table;

FIG. 4 is a flowchart illustrating operations performed by a controller;

FIG. 5 is a functional block diagram illustrating a group of functions realized in the document management apparatus; and

FIG. 6 is a diagram illustrating a document management table.

### DETAILED DESCRIPTION

Hereinafter, an exemplary embodiment of the present invention will be described in detail with reference to the accompanying drawings.

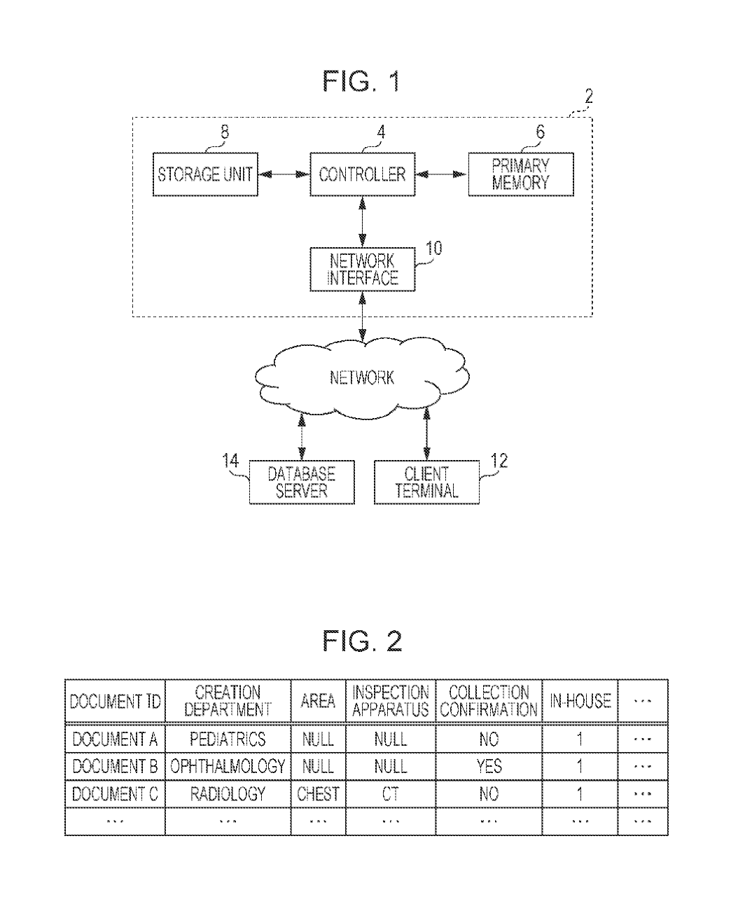

FIG. 1 is a diagram illustrating the structure of a document management apparatus 2 according to an exemplary embodiment of the invention. The document management apparatus 2 is installed in a given hospital X, and is implemented as a server computer that includes a controller 4, a primary memory 6, a storage unit 8, and a network interface 10 (hereinafter referred to as a “network I/F 10”). The controller 4 is a microprocessor that performs various types of information processing in accordance with a program stored in the primary memory 6. The primary memory 6 is implemented as a ROM and a RAM, and stores the program. The program is read from a computer readable information recording medium (for example, DVD (registered trademark)—ROM) and is stored in the primary memory 6. This program may be downloaded over a network and be stored in the primary memory 6.

The storage unit 8 is a hard disk that stores various types of information. The information stored in the storage unit 8 will be described below. The network I/F 10 is an interface that connects the document management apparatus 2 to the network. The document management apparatus 2 can exchange data with a client terminal 12 and a database server 14 over the network.

The client terminal 12 is a computer terminal used by staff of the hospital X so as to register an electronic document scanned from a paper document in the document management apparatus 2. More specifically, the client terminal 12 transmits the electronic document to the document management apparatus 2 together with its ID (hereinafter referred to as a “document ID”), in accordance with an instruction from the staff of the hospital X.

It is to be noted that the term “electronic document” as used herein indicates image data that represent the image of each page of a paper document and that are obtained from the scan results by a scanner.

The client terminal 12 is also used by the staff of the hospital X so as to register the properties of each electronic document in the database server 14. FIG. 2 is a document management table stored in the database server 14. The document management table indicates the properties of each electronic document. More specifically, the document management table stores data indicating the properties of electronic documents in association with document IDs of the respective electronic documents. More specifically, the document management table includes a document ID field. The document ID field stores the document ID of an electronic document. Further, the document management table includes fields other than the document ID field. The fields other than the document ID field store data indicating the properties of the electronic document that is identified by the document ID stored in the document ID field. More specifically, a creation department field stores the ID of a department which created the electronic document. For example, if an ID “OPHTHALMOLOGY” is stored in the creation department field, this indicates that the electronic document is an electronic document scanned from a paper document created by the Department of Ophthalmology.

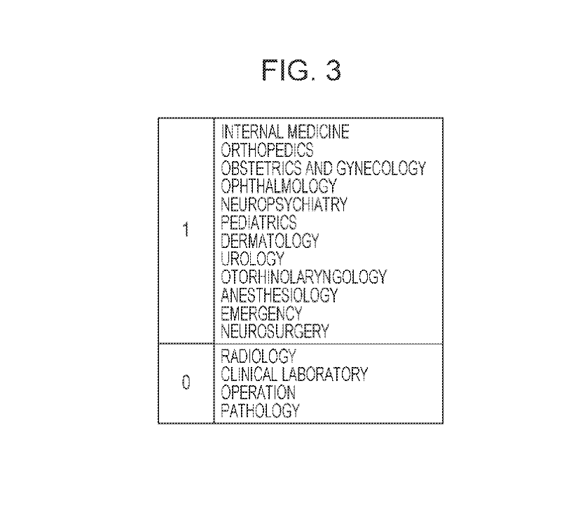

It is to be noted that the database server 14 stores a department table that indicates which departments are the clinical department that are mainly in charge of medical care. FIG. 3 illustrates the department table. The IDs of the clinical departments are associated with the value “1”, and non-clinical departments are associated with the value “0”.

Further, an area field and an inspection apparatus field store information indicating whether the electronic document is an electronic document scanned from a paper document containing an image captured by a medical inspection apparatus. If the electronic document is not an electronic document scanned from a paper document containing an image captured by a medical inspection apparatus, “null” is stored in each of the area field and the inspection apparatus field. On the other hand, if the electronic document is an electronic document scanned from a paper document containing an image captured by a medical inspection apparatus, the ID of the area in the image contained in the electronic document is stored in the area field, and the ID of the medical inspection apparatus that captured the image contained in the electronic document is stored in the inspection apparatus field.

A collection confirmation field stores a value indicating whether the electronic document is an electronic document scanned from a document, such as a consent form, that contains the signature or seal of a patient. The value “YES” indicates that the electronic document is an electronic document scanned from a document such as a consent form, and the value “NO” indicates that the electronic document is not an electronic document scanned from a document such as a consent form.

An in-house field stores a value indicating whether the electronic document is an electronic document scanned from an in-house paper document created by the hospital X. The value “1” indicates that the electronic document is an electronic document scanned from an in-house document, and the value “0” indicates that the electronic document is not an electronic document scanned from a paper document created by the hospital X (for example, the electronic document is a referral form provided by another hospital). The hospital X corresponds to a “specific hospital”.

It is to be noted that the document management table may store data that indicates other types of properties than the types of properties described above. For example, the document management table may store the title of the electronic document, the abbreviation of the title, the number of pages, the data format, and the like.

The document management apparatus 2 receives an electronic document transmitted from the client terminal 12, and compresses and stores the received electronic document in the storage unit 8 in order to effectively use the memory resources.

However, the document management apparatus 2 determines whether the received electronic document requires visual readability. If the electronic document requires visual readability, the document management apparatus 2 stores the electronic document in the storage unit 8 without compression. The following describes this point.

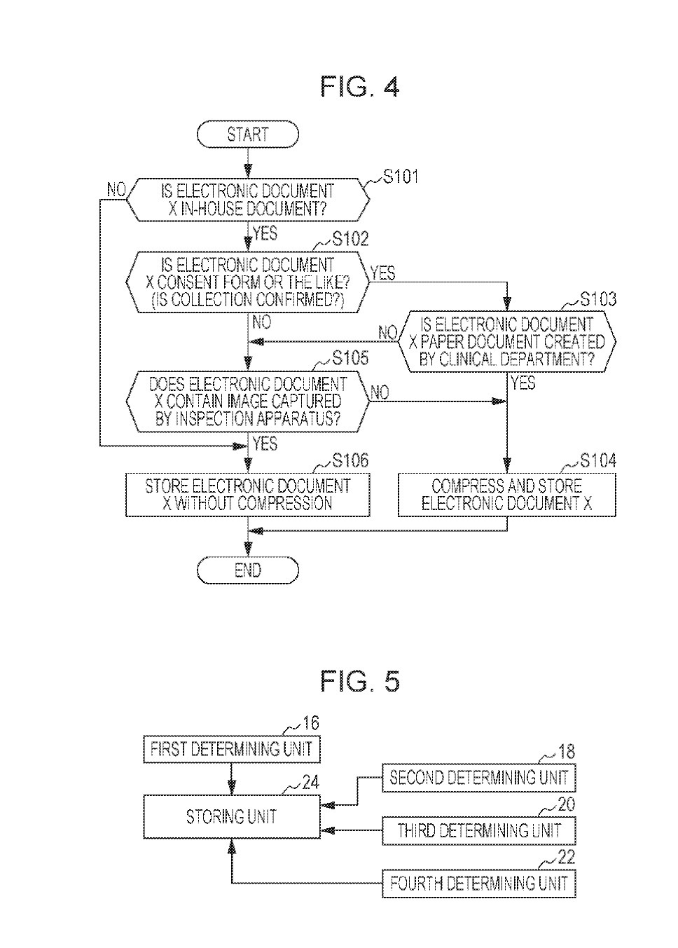

FIG. 4 is a flowchart illustrating operations performed by the controller 4 in the case where an electronic document (hereinafter referred to as an “electronic document X”) transmitted from the client terminal 12 is received by the document management apparatus 2.

First, the controller 4 determines whether the electronic document X is an electronic document scanned from an in-house document (S101) by referring to the document management table. More specifically, in Step S101, the controller 4 determines whether the value stored in the in-house field in association with the document ID of the electronic document X is “1”.

If the electronic document X is an electronic document scanned from a referral form created by another hospital, the electronic document X is likely to contain the medical records of the patient in the other hospital, and therefore requires visual readability. Therefore, in the case where the electronic document X is not an electronic document scanned from an in-house document (No in S101), the controller 4 stores the electronic document X in the storage unit 8 without compression (S106).

On the other hand, in the case where the electronic document X is an electronic document scanned from an in-house document (Yes in S101), the controller 4 determines whether the electronic document X is an electronic document scanned from a document such as a consent form that contains the signature or seal of a patient. More specifically, in Step S102, the controller 4 determines whether the value stored in the collection confirmation field in association with the document ID of the electronic document X is “YES”.

Documents containing the signature or seal of a patient are less likely to be used for medical actions. That is, electronic documents scanned from documents containing the signature or seal of a patient are less likely to require visual readability. However, even such a document may contain content (for example, an image captured by a medical inspection apparatus) that requires visual readability. Therefore, in the case where the electronic document X is an electronic document scanned from a document such as a consent form that contains the signature or seal of a patient (Yes in S102), in order to determine whether the electronic document X really does not require visual readability, the controller 4 determines whether the electronic document X is an electronic document scanned from a paper document created by a clinical department (S103). More specifically, in Step S103, the controller 4 determines whether the ID stored in the creation department field in association with the document ID of the electronic document X is associated with the value “1” in the department table.

Documents created by clinical departments mainly contain text information, and do not contain image information. Accordingly, it is certain that the electronic documents created by the clinical departments do not require visual readability. Therefore, in the case where the electronic document X is an electronic document scanned from a paper document created by a clinical department (Yes in S103), the controller 4 compresses the electronic document X and stores the compressed electronic document X in the storage unit 8 (S104).

It is to be noted that documents not containing the signature or seal of a patient may contain content, such as an image captured by a medical inspection apparatus, that requires visual readability. Even documents containing the signature or seal of a patient may contain content that requires visual readability, if the documents are created by a non-clinical department. Therefore, in the case where the electronic document X is not an electronic document scanned from a document such as a consent form that contains the signature or seal of a patient (No in S102), and in the case where the electronic document X is an electronic document scanned from a document such as a consent form that contains the signature or seal of a patient but is not an electronic document scanned from a paper document created by a clinical department (No in S103), the controller 4 performs the operation of step S105. That is, in 5105, the controller 4 determines whether the electronic document X contains an image captured by a medical inspection apparatus (S105). More specifically, in Step S105, the controller 4 determines whether both the values stored in the area field and the inspection apparatus field in association with the document ID of the electronic document X are not “null”.

Electronic documents containing an image captures by a medical inspection apparatus always require visual readability from the standpoint of the accuracy in detecting an affected area and the accuracy in interpreting radiographs. Therefore, in the case where the electronic document X contains an image captured by a medical inspection apparatus (Yes in S105), the controller 4 stores the electronic document X in the storage unit 8 without compression (S106). On the other hand, in the case where the electronic document X does not contain an image captured by a medical inspection apparatus (No in S105), the controller 4 compresses the electronic document X and stores the compressed electronic document X in the storage unit 8 (S104).

FIG. 5 is a functional block diagram illustrating a group of functions realized in the document management apparatus 2 when the controller 4 operates in accordance with the program described above. As illustrated in FIG. 5, a first determining unit 16, a second determining unit 18, a third determining unit 20, a fourth determining unit 22, and a storing unit 24 are realized in the document management apparatus 2.

The first determining unit 16 determines whether the electronic document X is an electronic document scanned from a paper document created by the hospital X (see 5101 of FIG. 4).

The second determining unit 18 determines whether the electronic document X is an electronic document scanned from a document such as a consent form that contains the signature of seal of a patient (see 5102 of FIG. 4). In this exemplary embodiment, in the case where the electronic document X is an electronic document scanned from a paper document created by the hospital X, the second determining unit 18 determines whether the electronic document X is an electronic document scanned from a document such as a consent form.

The third determining unit 20 determines whether the electronic document X is an electronic document scanned from a paper document created by a clinical department of the hospital (see 5103 of FIG. 4). In this exemplary embodiment, in the case where the second determining unit 18 determines that the electronic document X is an electronic document scanned from a document such as a consent form, the third determining unit 20 determines whether the electronic document X is an electronic document scanned from a paper document created by a clinical department of the hospital.

The fourth determining unit 22 determines whether the electronic document X is an electronic document scanned from a paper document containing an image captured by a medical inspection apparatus (S105) (see 5105 of FIG. 4). In this exemplary embodiment, in the case where the second determining unit 18 determines that the electronic document X is not an electronic document scanned from a document such as a consent form, and in the case where the third determining unit 20 determines that the electronic document X is an electronic document scanned from a paper document created by a clinical department of the hospital, the fourth determining unit 22 determines whether the electronic document X is an electronic document scanned from a paper document containing an image captured by a medical inspection apparatus.

In the case where the first determining unit 16 determines that the electronic document X is an electronic document scanned from a paper document created by the hospital X, the storing unit 24 stores the electronic document X in the storage unit 8 without compression.

On the other hand, in the case where the first determining unit 16 determines that the electronic document X is an electronic document scanned from a paper document created by the hospital X, the storing unit 24 stores the compressed electronic document X in the storage unit 8 if the second determining unit 18 determines that the electronic document X is an electronic document scanned from a document such as a consent form, or if the fourth determining unit 22 determines that the electronic document X is not an electronic document scanned from a paper document containing an image captured by a medical inspection apparatus. More specifically, in the case where the first determining unit 16 determines that the electronic document X is an electronic document scanned from a paper document created by the hospital X, and where the second determining unit 18 determines that the electronic document X is an electronic document scanned from a document such as a consent form, the storing unit 24 stores the compressed electronic document X in the storage unit 8 if the third determining unit 20 determines that the electronic document X is an electronic document scanned from a paper document created by a clinical department, or if the fourth determining unit 22 determines that the electronic document X is not an electronic document scanned from a paper document containing an image captured by a medical inspection apparatus.

That is, in this exemplary embodiment, in the case where the first determining unit 16 determines that the electronic document X is an electronic document scanned from a paper document created by the hospital X, the storing unit 24 stores the compressed electronic document X in the storage unit 8 if the fourth determining unit 22 determines that the electronic document X is not an electronic document scanned from a paper document containing an image captured by a medical inspection apparatus, and stores the electronic document X in the storage unit 8 without compression if the fourth determining unit 22 determines that the electronic document X is an electronic document scanned from a paper document containing an image captured by a medical inspection apparatus.

The present invention is not limited to the exemplary embodiment described above.

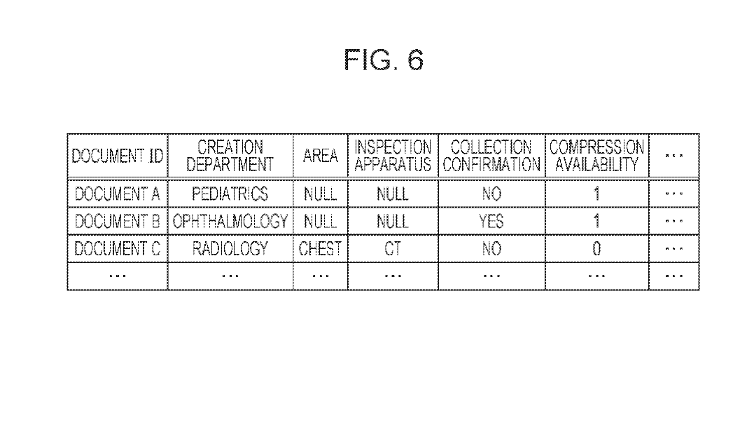

For example, a document management table illustrated in FIG. 6 may be stored in the database server 14 in place of the document management table illustrated in FIG. 2. The document management table of FIG. 6 includes a compression availability field in place of the in-house field. The compression availability field stores “1” if the electronic document may be compressed, and stores “0” if the electronic document may not be compressed. In this case, the controller 4 may perform operations described below in place of the operations of FIG. 4. More specifically, the controller 4 may determine whether the electronic document X may be compressed on the basis of the value stored in the compression availability field in association with the document ID of the electronic document X. If the electronic document X may be compressed, the controller 4 may compress and store the electronic document X in the storage unit 8. On the other hand, if the electronic document X may not be compressed, the controller 4 may store the electronic document X in the storage unit 8 without compression.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document processing apparatus comprising:
a document acquiring unit that acquires image information representing an electronic document;
a unit that determines whether the electronic document represented by the image information is an electronic document scanned from a document created by a specific hospital; and
a storing unit that stores the image information in a memory if the electronic document represented by the image information is not an electronic document that is scanned from a document created by the specific hospital, and stores compressed image information in the memory in place of the image information if the electronic document represented by the image information is an electronic document scanned from a document created by the specific hospital, the compressed image information being obtained by compressing the image information.

2. The document processing apparatus according to claim 1, further comprising:
a unit that determines whether the electronic document represented by the image information is an electronic document scanned from a document containing an image captured by a medical apparatus;
wherein, in the case where the electronic document represented by the image information is an electronic document scanned from a document created by the specific hospital, the storing unit stores the compressed image information in the memory if the electronic document represented by the image information is not determined to be an electronic document that is scanned from a document containing an image captured by a medical apparatus, and stores the image information in the memory in place of the compressed image information if the electronic document represented by the image information is determined to be an electronic document that is scanned from a document containing an image captured by a medical apparatus.

3. The document processing apparatus according to claim 2, further comprising:
a unit that determines whether the electronic document represented by the image information is an electronic document scanned from a document containing a seal or signature;
wherein, in the case where the electronic document represented by the image information is an electronic document scanned from a document created by the specific hospital, the storing unit stores the compressed image information in the memory if the electronic document represented by the image information is determined to be an electronic document scanned from a document containing a seal or signature, or if the electronic document represented by the image information is not determined to be an electronic document that is scanned from a document containing an image captured by a medical apparatus.

4. The document processing apparatus according to claim 3, further comprising:
a unit that determines whether the electronic document represented by the image information is an electronic document scanned from a document created by a specific department of the hospital;
wherein, in the case where the electronic document represented by the image information is an electronic document scanned from a document created by the specific hospital, and where the electronic document represented by the image information is an electronic document scanned from a document containing a seal or signature, the storing unit stores the compressed image information in the memory if the electronic document represented by the image information is determined to be an electronic document scanned from a document created by the specific department of the hospital, or if the electronic document represented by the image information is not determined to be an electronic document that is scanned from a document containing an image captured by a medical apparatus.

5. A document processing method comprising:
acquiring image information representing an electronic document;
determining whether the electronic document represented by the image information is an electronic document scanned from a document created by a specific hospital; and
storing the image information in a memory if the electronic document represented by the image information is not an electronic document that is scanned from a document created by the specific hospital, and storing compressed image information in the memory in place of the image information if the electronic document represented by the image information is an electronic document scanned from a document created by the specific hospital, the compressed image information being obtained by compressing the image information.

6. A non-transitory computer readable medium storing a program causing a computer to execute a document processing process, the process comprising:
acquiring image information representing an electronic document;
determining whether the electronic document represented by the image information is an electronic document scanned from a document created by a specific hospital; and
storing the image information in a memory if the electronic document represented by the image information is not an electronic document that is scanned from a document created by the specific hospital, and storing compressed image information in the memory in place of the image information if the electronic document represented by the image information is an electronic document scanned from a document created by the specific hospital, the compressed image information being obtained by compressing the image information.
